(19) United States
(12) Patent Application Publication
(10) Pub. No.: US 2006/0132823 A1
(43) Pub. Date: Jun. 22, 2006

(54) Printing system

(75) Inventor: Daiki Sakamoto, Numazu-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/233,181

(22) Filed: Sep. 21, 2005

Related U.S. Application Data
(63) Continuation-in-part of application No. 11/015,497, filed on Dec. 16, 2004, now abandoned.

(51) Int. Cl. G06K 15/00

(52) U.S. Cl. 358/1.14

(57) ABSTRACT

In a network that connects a plurality of computers and a printing apparatus, a printing system whose printing apparatus receives a print job from the computers and performs printing based on the received print job, includes a function restriction information storage unit which stores function restriction information that restricts a printing function for each of groups divided according to users of the computers, and a control unit which inhibits a restricted printing function from being fulfilled based on the function restriction information stored in the function restriction information storage unit in accordance with a group of one of the computers when the one of the computers uses the printing apparatus to perform printing.

### CROSS-REFERENCE TO RELATED APPLICATIONS

This is a Continuation-in-Part application of U.S. patent application Ser. No. 11/015,497, filed Dec. 16, 2004, now abandoned, the entire contents of which are incorporated herein by reference.

### BACKGROUND OF THE INVENTION

1. Field of the Invention

The present invention relates to a printing system that performs different types of printing using a printing apparatus capable of restricting printing functions.

2. Description of the Related Art

There is a case where a printing apparatus installed in an office and the like is shared among a plurality of predetermined groups, e.g., a plurality of departments. The printing apparatus so shared includes a counter for each of the departments to count the number of prints. Whenever printing is done in a department, the counter of the department counts up. Billing of the apparatus for each of the departments is managed based on the number of counts of the counter.

Some printing apparatuses have printing functions such as stapling and punching. However, the apparatuses only manage billing by counting the number of prints for each of the departments as described above and do not restrict the functions for each of the departments.

Even though there is a department that wishes to impose restrictions on printing settings such as a large number of prints, stapling and punching, they cannot be imposed. Similarly, no restrictions can be imposed on a department that wishes to do printing all the time at a specific printing setting such as 2in1 printing.

Accordingly, there is a need for a printing system and a printing apparatus capable of restricting printing functions for each of predetermined groups.

### BRIEF SUMMARY OF THE INVENTION

According to one aspect of the present invention, there is provided a printing system in a network that connects a plurality of computers and a printing apparatus, the printing apparatus receiving a print job from the computers and performing printing based on the received print job, the printing system comprising a function restriction information storage unit which stores function restriction information that restricts a printing function for each of groups divided according to users of the computers, and a control unit which inhibits a restricted printing function from being fulfilled based on the function restriction information stored in the function restriction information storage unit in accordance with a group of one of the computers when the one of the computers uses the printing apparatus to perform printing.

Objects and advantages of the invention will be become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a schematic diagram of a network structure according to a first embodiment of the present invention;

FIG. 2 is a schematic diagram of the internal structure of a printing apparatus according to the embodiment of the present invention;

FIG. 3 is a diagram showing an example of a restriction setting table according to the embodiment of the present invention;

FIG. 4 is a diagram showing another example of the restriction setting table according to the embodiment of the present invention;

FIG. 5 is a schematic diagram of the internal structure of a PC according to the embodiment of the present invention;

FIG. 6 is a flowchart showing a process to be performed by a CPU of the PC according to the embodiment of the present invention;

FIG. 7 is a flowchart showing a process to be performed by a CPU of the printing apparatus according to the embodiment of the present invention;

FIG. 8 is a diagram showing a printer driver user interface according to the embodiment of the present invention;

FIG. 9 is a diagram showing an example of display of items of printing functions settable by a tab “setup” which are restricted in the embodiment of the present invention;

FIG. 10 is a diagram showing an example of display of items of printing functions settable by the tab “setup” in the embodiment of the present invention;

FIG. 11 is a diagram showing an example of display of items of printing functions settable by a tab “effect” which are restricted in the embodiment of the present invention;

FIG. 12 is a diagram showing an example of display of items of printing functions settable by the tab “effect” in the embodiment of the present invention;

FIG. 13 is a schematic diagram of a network structure according to a second embodiment of the present invention;

FIG. 14 is a flowchart showing a process at the time of initial-setting of a printer driver in the embodiment;

FIG. 15 is a flowchart showing a process at the time of initial-setting of a printing apparatus in the embodiment;

FIG. 16 is a flowchart showing a process at the time of printing in the embodiment;

FIG. 17 is a flowchart showing an anterior half of a process when the printing apparatus receives a print job in the embodiment;

FIG. 18 is a flowchart showing a posterior half of a process when the printing apparatus receives a print job in the embodiment;

FIG. 19 is a flowchart showing a process of a PC of an administrator when a notice reaches from the printing apparatus; and

FIG. 20 is a diagram showing an example of display of the PC of the administrator.

### DETAILED DESCRIPTION OF THE INVENTION

Embodiments of the present invention will be described below with reference to the drawings.

### FIRST EMBODIMENT

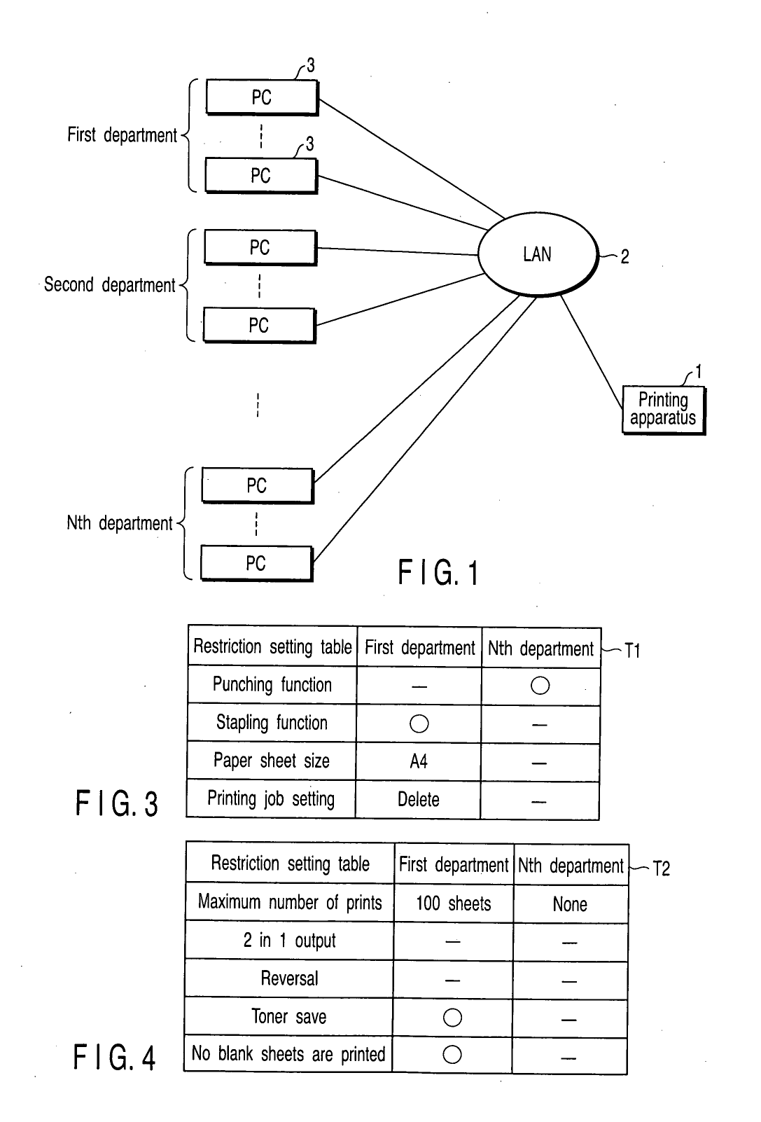

FIG. 1 is a schematic diagram of a network structure. A printing apparatus 1 is installed in an office and the like. A plurality of PCs 3 are connected to the printing apparatus 1 via a local network area (LAN) 2. The printing apparatus 1 is shared by a plurality of groups such as a first department, a second department, . . . , an N-th department. Each of the departments has a plurality of PCs 3.

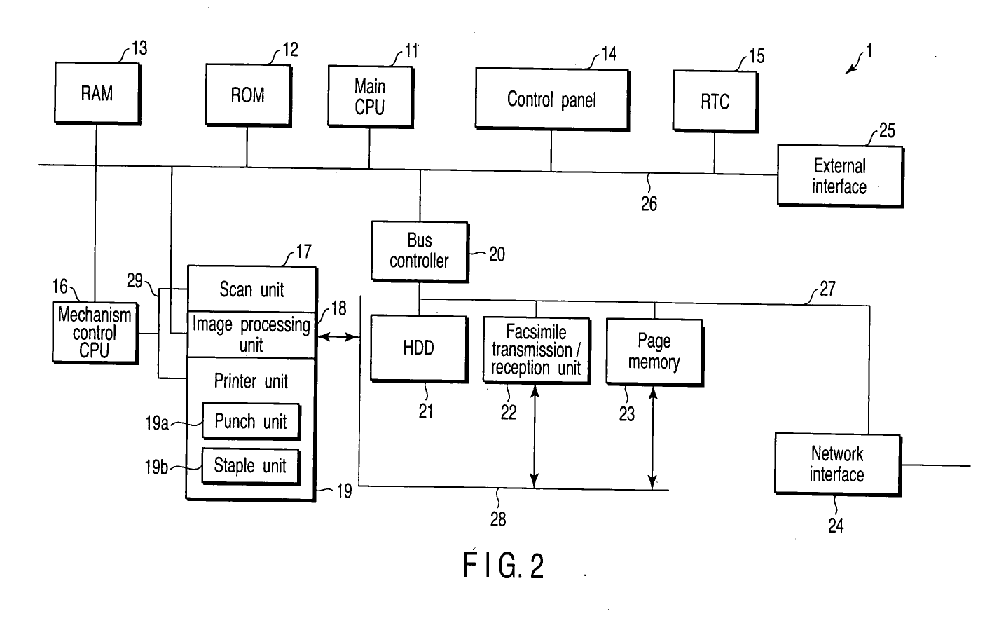

FIG. 2 is a schematic diagram of the internal structure of the printing apparatus 1. The internal structure of the printing apparatus 1 is made up of a main CPU 11, a ROM 12, a RAM 13, a control panel 14, a real time clock (RTC) 15, a mechanism control CPU 16, a scan unit 17, an image processing unit 18, a printer unit 19, a bus controller 20, a hard disk drive (HDD) 21, a facsimile transmission/reception unit 22, a page memory 23, a network interface 24, an external interface 25 and the like.

The main CPU 11, ROM 12, RAM 13, control panel 14, RTC 15, mechanism control CPU 16, image processing unit 18, bus controller 20 and external interface 25 are connected to one another through a bus line 26. The bus controller 20, HDD 21, facsimile transmission/reception unit 22, page memory 23 and network interface 24 are connected to one another through a bus line 27. The image processing unit 18, facsimile transmission/reception unit 22 and page memory 23 are connected to one another through a bus line 28. The mechanism control CPU 16 is connected to the scan unit 17 and printer unit 19 through a bus line 29.

The main CPU 11 executes the control programs stored in the ROM 12 to control the respective units in their entirety. The ROM 12 stores, for example, control programs to be executed by the main CPU 11. The RAM 13 has a work area necessary for performing various processes by the main CPU 11.

The control panel 14 has various keys such as numeric keys and a start key and a touch panel. The control panel 14 receives user's instructions from the keys and the touch panel and displays information necessary for a user on the touch panel. The RTC 15 generates present time information such as date and time.

The mechanism control CPU 16 controls the mechanical operations of the scan unit 17 and printer unit 19. The scan unit 17 uses a scanner to read an image of a document sent from, e.g., an automatic document feeder (ADF) not shown and generates image data. The scan unit 17 sends the image data to, e.g., the image processing unit 18. The image processing unit 18 subjects the image data sent from the scan unit 17 to predetermined image processing. The image data is output to the facsimile transmission/reception unit 22 or the page memory 23. When the printer unit 19 receives, e.g., the temporarily stored image data from the page memory 23, it prints the image data. The printer unit 19 has a punch unit 19a for fulfilling a punch function of punching a printed paper sheet in its given position and a staple function of stapling printed paper sheets for every paper sheet count.

The bus controller 20 is controlled by the main CPU 11 and used to control the transmission destination of various items of data. The page memory 23 temporarily stores image data. The facsimile transmission/reception unit 22 receives or transmits a facsimile via the external interface 25. The network interface 24 is used for a connection with the LAN 2.

The HDD 21 stores data such as an image read by the scan unit 17 and e-mail received through the network interface 24. The HDD 21 is provided with a restriction setting table T1 for setting function restriction information indicative of restrictions on printing functions as illustrated in FIG. 3.

According to the restriction setting table T1, the staple function is restricted to the first department and the punch function is restricted to the N-th department. The first department is set such that only A4-size paper sheets can be printed. A printing job setting is set for each of departments registered in table T1. If the printing setting of a received print job includes a restricted function, the print job is forcibly deleted. For this deletion, for example, “delete” is set in the printing job setting. As shown in table T1, “delete” is set in the printing job setting of the first department. Since no printing functions such as a punch function and a staple function are restricted to the other departments such as the second department, there are not set in table T1. The settings of table T1 are performed by, for example, an administrator of the printing apparatus 1 using the control panel 14.

This embodiment is directed to the settings of restrictions on the punch function, staple function and paper sheet size with reference to the restriction setting table T1. However, the settings of restrictions on printing functions are not limited to those of the embodiment. In addition to the settings of restrictions described with reference to table T1, the restrictions on a maximum prints setting function, a 2in1 (Nin1) function, a reverse function, a toner save function, and a function of not printing any blank sheets can be set for each of the departments as shown in restriction setting table T2 in FIG. 4. The reverse function is a function of reverse printing in black and white. The function is always restricted when printing is done in color. The toner save function is fulfilled to save toner and the blank sheet printing function is done not to print a blank sheet at default settings. If these functions are restricted, their settings cannot be cleared. Consequently, when the printing apparatus 1 receives a print job from the PC 3 of the department, it always saves toner and does not print any blank sheets.

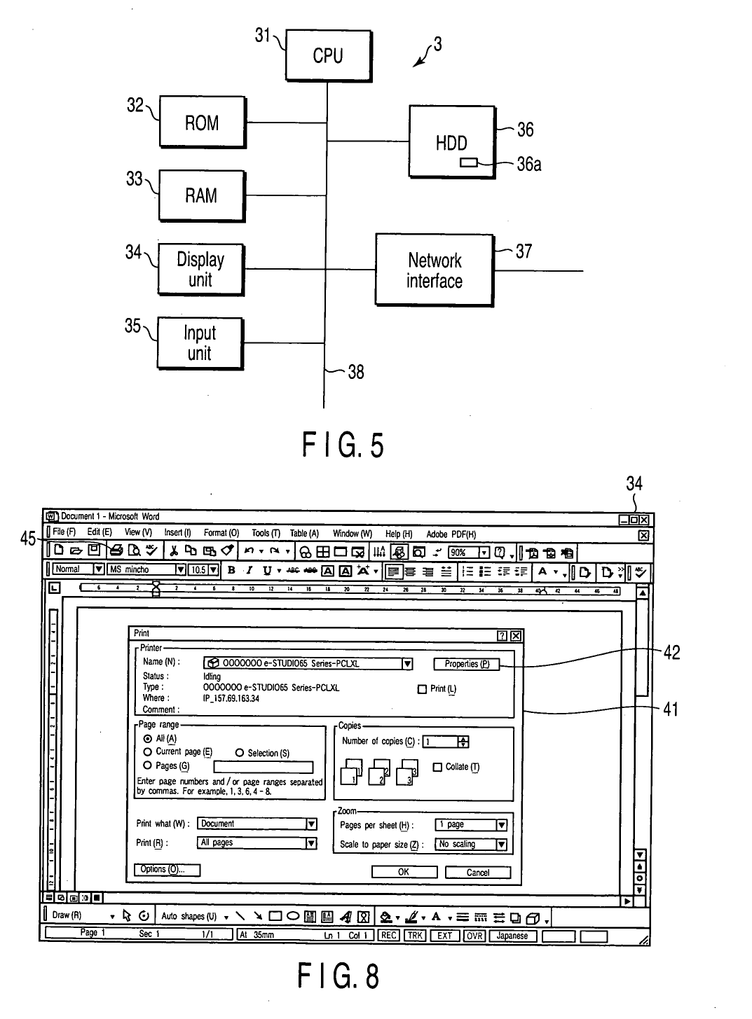

FIG. 5 is a schematic diagram of the internal structure of the PC 3. The PC 3 includes a CPU 31, a ROM 32, a RAM 33, a display unit 34, an input unit 35, an HDD 36 and a network interface 37. The CPU 31 is connected to the ROM 32, RAM 33, display unit 34, input unit 35, HDD 36 and network interface 37 through a bus line 38.

The CPU 31 executes the control programs stored in the ROM 32 to control the respective units in their entirety. The ROM 32 stores, for example, control programs to be executed by the CPU 31. The RAM 33 has a work area necessary for performing various processes by the CPU 31. The display unit 34 is, for example, a display to display information for a user. The input unit 35 is, for example, a keyboard and a mouse to be used for inputting user's instructions. The network interface 37 is used for a connection with the LAN 2.

The HDD 36 stores various types of application software and various types of data. The HDD 36 also stores a printer driver of the printing apparatus 1. The printer driver is installed by an administrator of the printing apparatus 1. At same time the printer driver is installed, the administrator inputs department information indicating which of the first to Nth departments the PC 3 is used in. This department information is stored in, for example, a department information storage unit 36a of the HDD 36.

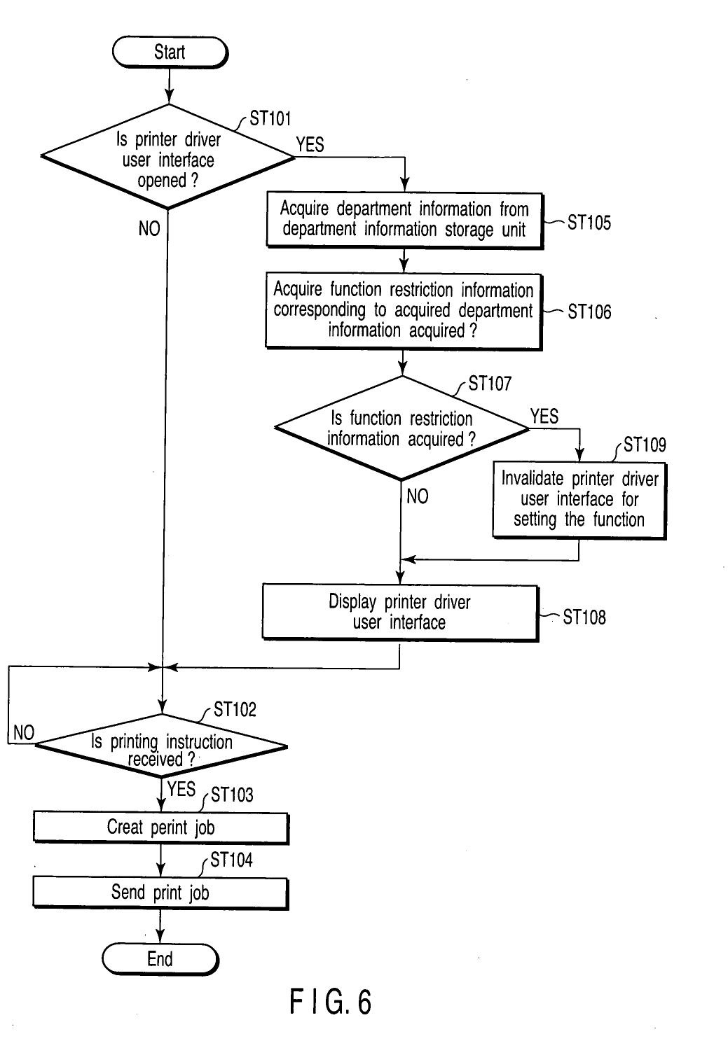

FIG. 6 is a flowchart showing a process to be performed by the CPU 31 (printer driver) of the PC 3 when the PC 3 performs printing using the printing apparatus 1.

First, the CPU 31 determines whether to open a printer driver user interface for receiving the settings of printing functions (ST101). If NO, then the CPU 31 determines that an instruction to print is received from the input unit 35 (ST102). If the CPU 31 determines that the instruction is received, it creates a print job (ST103). The department information stored in the department information storage unit 36a is added to the header of the created print job. The CPU 31 sends the created print job to the printing apparatus 1 (ST104).

If YES in step ST101, the CPU 31 acquires the department information from the department information storage unit 36a (ST105). The CPU 31 communicates with the printing apparatus 1 and acquires function restriction information from the restriction setting table T1 of the printing apparatus 1 in accordance with the acquired department information (ST106). Then, the CPU 31 determines whether the function restriction information can be acquired (ST107). If the CPU 31 determines that the function restriction information cannot be acquired, or if the department indicated by the department information is not set in the restriction setting table T1, the CPU 31 displays the printer driver user interface on the display unit 34 (ST108).

If the CPU 31 determines that the function restriction information can be acquired, or if the department indicated by the department information is set in the restriction setting table T1, the CPU 31 invalidates a restricted function. In order to present the invalid function to a user, the display color for setting the invalid function is caused to differ from that for doing a valid function. Specifically, the display color for setting an unrestricted function is black, and that for doing a restricted function is gray (ST109). The CPU 31 advances to step ST108 to display the printer driver user interface on the display unit 34 (ST108). At this time, the printer driver user interface is displayed such that the restricted function becomes invalid.

After the printer driver user interface is displayed on the display unit 34 in step ST108, the CPU 31 determines whether it receives an instruction to print from the input unit 35 (ST102). The CPU 31 creates a print job (ST103) and sends the created print job to the printing apparatus 1 (ST104).

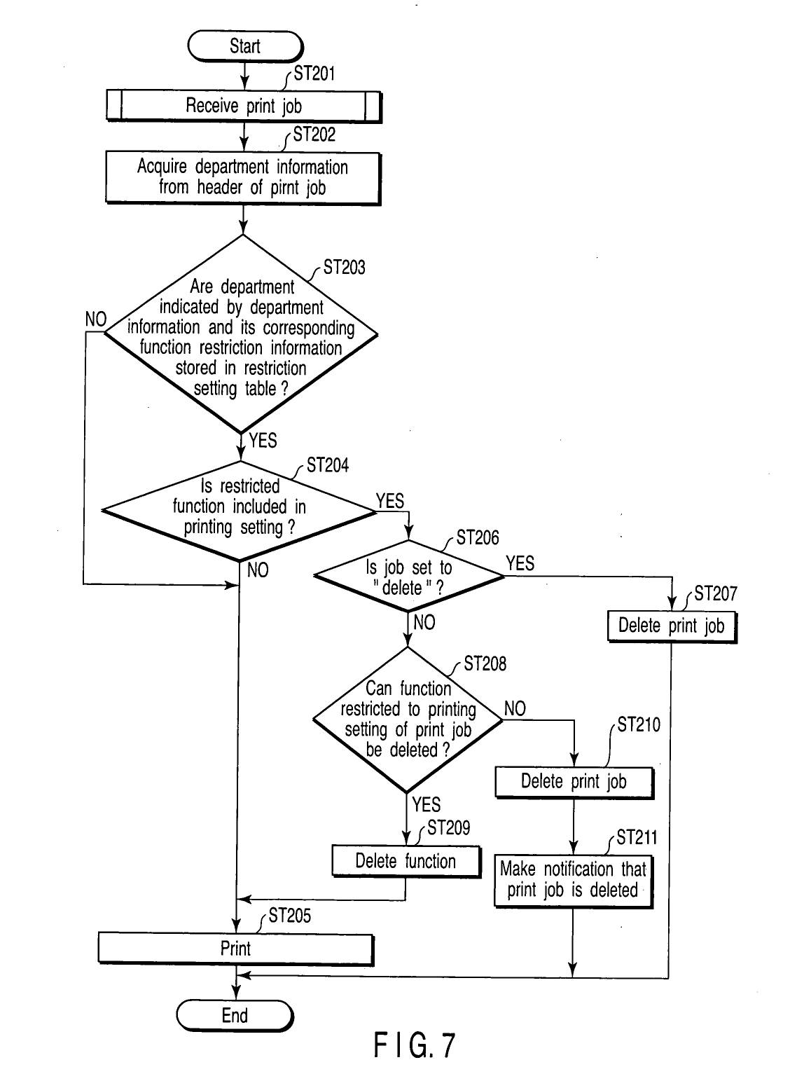

FIG. 7 is a flowchart showing a process to be performed by the main CPU 11 of the printing apparatus 1 when the main CPU 11 receives a print job from the PC 3.

When the main CPU 11 receives a print job (ST201), it acquires department information from the header of the received print job (ST202). The main CPU 11 determines whether function restriction information corresponding to a department indicated by the acquired department information is stored in the restriction setting table T1 (ST203). If the main CPU 11 determines that the function restriction information is stored in the table T1, it determines whether the function restricted by the table T1 is included in the printing settings of the print job (ST204). If the main CPU 11 determines that the function restriction information is not stored in the table T1 in step ST203 and it determines that a restricted function is not included in the printing settings of the print job in step ST204, it performs printing (ST205).

On the other hand, if the main CPU 11 determines that a restricted function is included in the printing settings of the print job in step ST204, it determines whether the printing job setting of the department indicated by the department information is set to “delete” (ST206). If it is set to “delete,” the main CPU 11 forcibly deletes the received print job (ST207) and ends the process. If it is not set to “delete,” the main CPU 11 determines whether the restricted function can be deleted or not (ST208). If the main CPU 11 determines that the restricted function can be deleted, it deletes the function (ST209) and performs printing (ST205). If the main CPU 11 determines that the restricted function cannot be deleted, it deletes the received print job (ST210), notifies a sender of the print job that the print job is deleted (ST211), and ends the process.

An explanation will be made of an operation of printing data indicative of the contents created by application software of the PC 3 that stores department information of the first department in the printing apparatus 1 so configured and the network to which the PC 3 so configured is connected. There are two cases where printing is performed as it is from an application (the printer driver is set at a default) and printing is performed from a printer driver interface after a printer driver user interface is opened. Each of the cases will be described below in terms of color printing.

First, the case where printing is performed from the printer driver user interface will be described. When printing is performed, a user gives an instruction to open the printer driver user interface from the application of the PC 3, for example, a user inputs a “file (F)” on the application and then selects “print (P)” from among selectable items.

If the above input is performed by the user, the CPU 31 acquires the function restriction information set for the first department from the printing apparatus 1. As shown in the restriction setting table T1 in FIG. 3, the first department is restricted so as not to select a staple function or paper size. Thus, the first department is set by the printer driver user interface so as not to receive the settings of the staple function or paper size and then the CPU 31 displays the printer driver interface on the display unit 34. FIG. 8 is a diagram showing a printer driver user interface 41 displayed on the display unit 34.

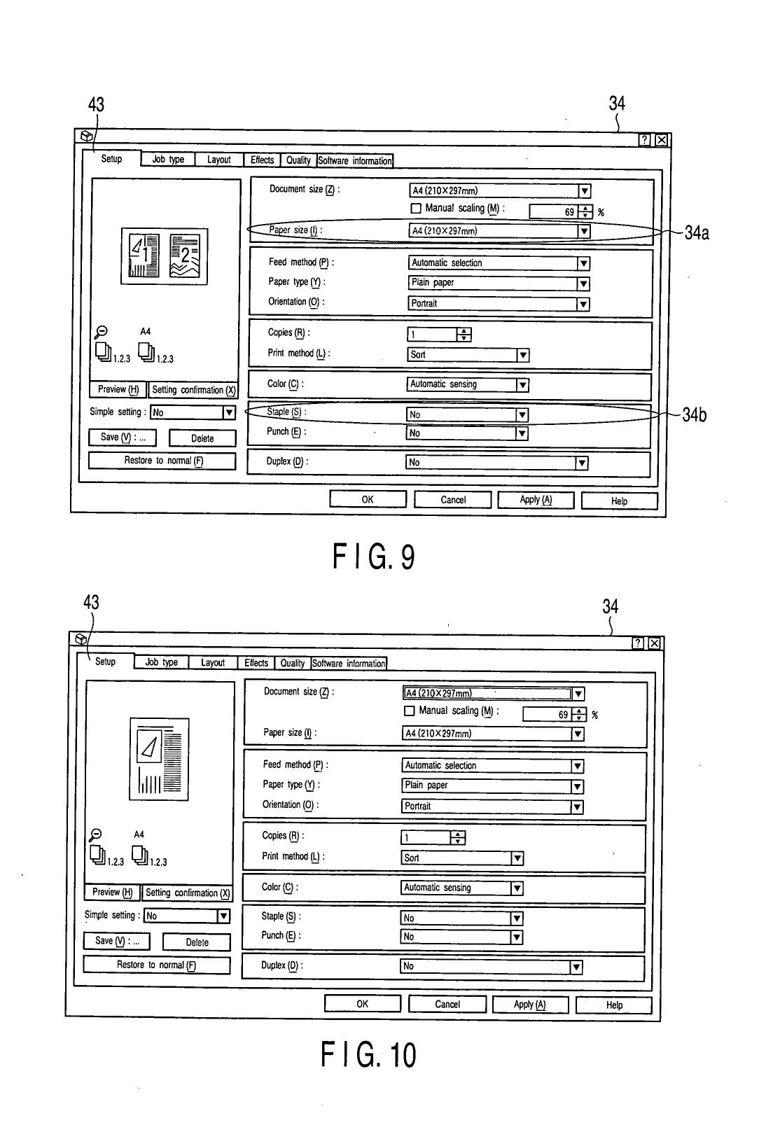

Inputting “property (P)” 42 shown in FIG. 8, the items of printing functions settable by a tab “setup” 43 are displayed. FIG. 9 is a diagram of the items of printing functions settable by the setup. As shown in FIG. 9, an item 34a of the function of selecting a paper size and an item 34b for setting a staple function are displayed in gray in the first department. In contrast, an item of the function capable of setting a paper feeding method or the like is displayed in black. A user can thus visually confirm that neither the paper size nor the staple function can be selected. As compared with FIG. 9, FIG. 10 shows the display of items of printing functions which are settable by the tab “setup” 43 (or which are not restricted). There are no items that are displayed in gray and do not receive the settings of the functions. All the items capable of setting the functions are displayed in black.

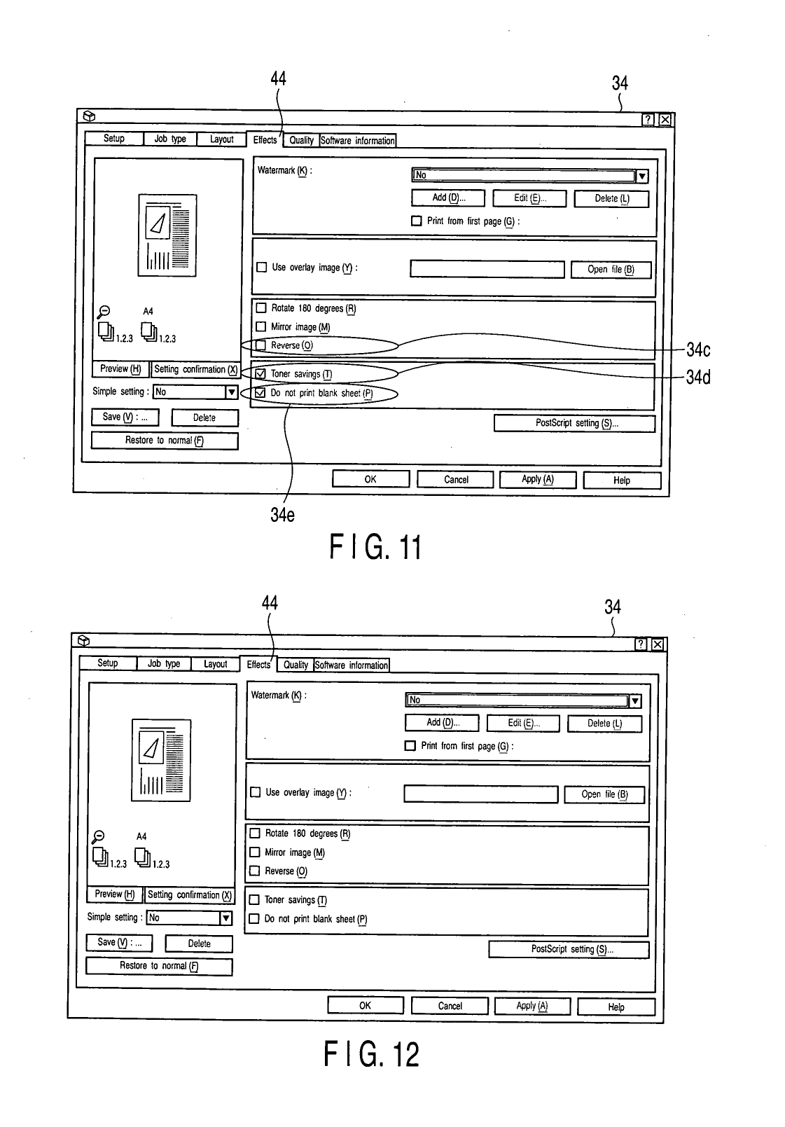

When the restrictions of saving toner and not printing any blank sheets are set in the first department as indicated in the restriction setting table T2 in FIG. 5, if a tab “effect” 44 is input, an item 34d for setting the toner save function and an item 34e for setting the function of not printing any blank sheets are displayed in gray so that a user can visually confirm that the items are not settable. For color printing, an item 34c for setting a reverse function is displayed in gray. In contrast, an item of the function capable of setting a watermark is displayed in black. As compared with FIG. 11, FIG. 12 shows the display of items of printing functions which are settable by the tab “effect” 44 (or which are not restricted). There are no items that are displayed in gray and do not receive the settings of the functions. All the items capable of setting the functions are displayed in black.

A case where printing is performed directly from an application will be described. A user inputs an icon 45 to which printing is assigned from a tool bar of application software in the display screen shown in FIG. 8. In this case, a print job is created from a printer driver at the default printing settings and transmitted to the printing apparatus 1.

The printing apparatus 1 determines whether the first department indicated by the department information described in the header of the received print job is set in the restriction setting table T1 shown in FIG. 3. Since it is set, the printing apparatus determines whether the printing settings of the print job includes the staple function restricted to the first department. Since, normally, the staple function is not set at default settings, the printing apparatus determines that the print job does not include the staple function and performs printing. If a user changes the default settings of the printer driver and the print job includes the staple function, the print job is deleted based on the “delete” of the printing job setting to the first department in the table T1 shown in FIG. 3. When the printing job setting is not set at “delete,” the printing apparatus determines whether the staple function can be deleted or not. Since the staple function can be deleted, the printing apparatus performs normal printing without stapling. If a function cannot be deleted, the print job is deleted and a notification that the print job is deleted is sent to the PC 3. This notification allows the user to know that the print job has been deleted.

Since, therefore, the restriction on the printing function is set for each of the departments, printing cannot be done using the restricted printing function. Paper sheets, toner, staples and the like can thus be prevented from being wasted in a specific department to improve the convenience of the printing apparatus 1. More specifically, staples can be prevented from being wasted by restricting the staple function to a specific department. Further, paper sheets and toner can be prevented from being wasted by printing intentionally and constantly at the same printing setting such as Nin1.

### SECOND EMBODIMENT

Next, a second embodiment of the present invention will be described. Note that portions which are the same as those in the first embodiment described above are denoted by the same reference numerals, and descriptions of the same portions as those as in the first embodiment will be omitted. In the printing apparatus 1 of the first embodiment, all print jobs in a department in which restrictions are imposed on the functions of the printing apparatus 1 are processed in the same way. In this case, it is necessary to change the settings in the restriction setting table T1 with respect to the entire department in a case where a user wishes to exceptionally use a restricted function, or the like. In this second embodiment, when the printing apparatus 1 capable of imposing restrictions on utilizing the functions which the printing apparatus 1 has for each of the departments registered in the printing apparatus 1 receives a print job to which restriction on the function has been added, it is possible for the administrator of the printing apparatus 1 to determine process for the print job.

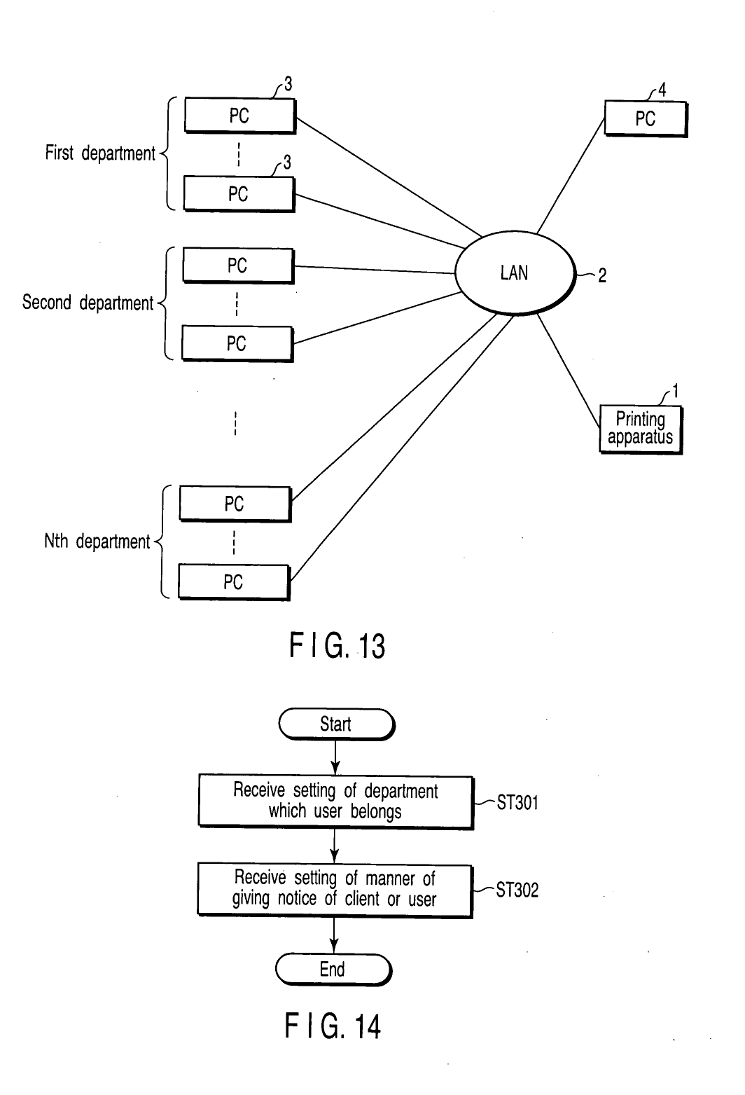

FIG. 13 is a schematic diagram of a network structure according to the second embodiment. As shown in FIG. 13, in addition to the network structure in the first embodiment, a PC 4 of the administrator of the printing apparatus 1 is connected to the LAN 2. The administrator administrates the printing apparatus 1, the PCs 3 of the respective departments, and the like which are connected to the LAN 2, by using the PC 4. The physical structure of the PC 4 is same as that of the PC 3, and thus is not shown in the figure, but same members are denoted by the same reference numerals.

Next, initial setting for a printer driver to be installed in each PC 3 will be described. FIG. 14 is a flowchart showing a process at the time of initial-setting of a printer driver. First, the CPU 31 of the PC 3 receives the setting for a department to which a user belongs (ST301). The setting for the department is acquired from, for example, login information at the time of connecting to the LAN 2. Note that the setting for the department may be carried out by a registration due to an input by the administrator, a registration due to an input by a user, or the like. Subsequently, the CPU 31 receives the setting of an address (a manner of giving notice) of the PC 3 or the user (ST302). For example, an IP address of the PC 3, an e-mail address of the user, or the like is set. In this way, initial setting when the printer driver is installed in the PC 3 is carried out.

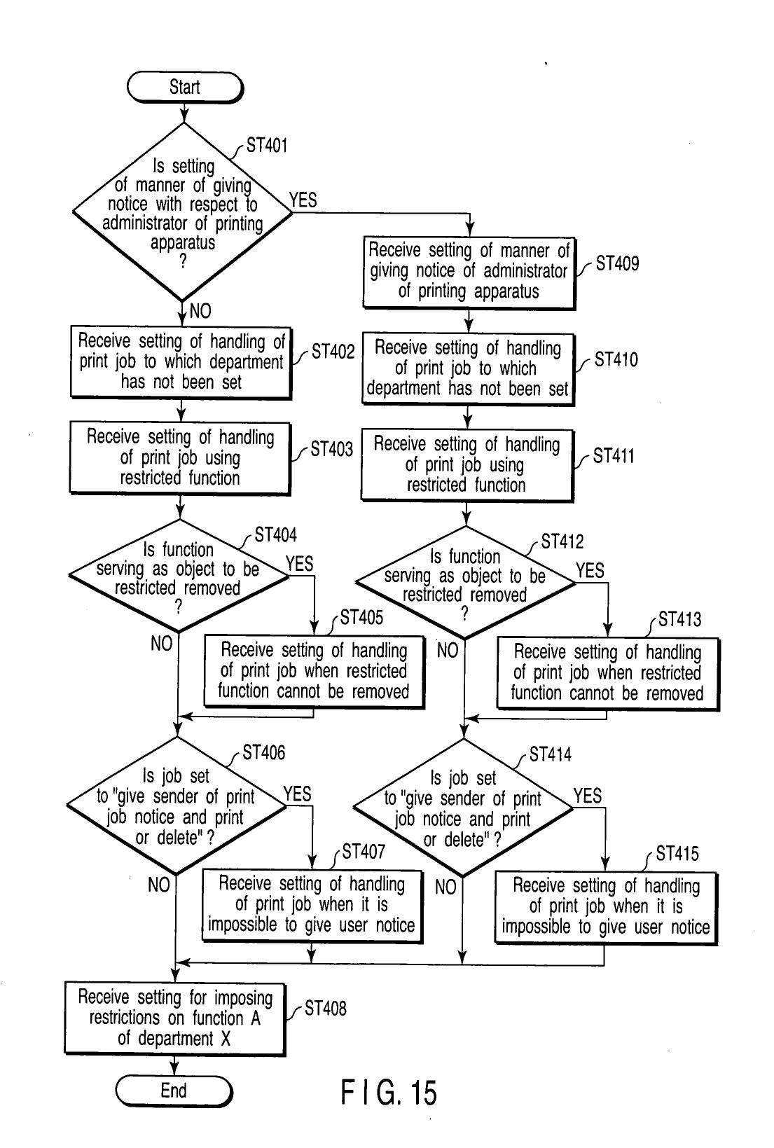

Next, initial setting for the printing apparatus 1 will be described. FIG. 15 is a flowchart showing a process at the time of initial-setting of the printing apparatus 1. First, the main CPU 11 determines whether or not to set a manner of giving notice, such as an IP address or an e-mail address, with respect to the administrator of the printing apparatus 1 (ST401). When the main CPU 11 determines to not set a manner of giving notice with respect to the administrator (NO in ST401), the main CPU 11 receives the setting of handling of a print job for which a department has not been set (ST402). Accordingly, one of the four of “print”, “give a sender of the print job notice and print”, “delete”, and “give a sender of the print job notice and delete” is set. Next, the main CPU 11 receives the setting of handling of a print job using the restricted function (ST403). Consequently, one of the five of “print”, “give a sender of the print job notice and print”, “delete”, “give a sender of the print job notice and delete”, and “remove a function serving as an object to be restricted” is set. Then, the main CPU 11 determines whether or not the setting for “remove a function serving as an object to be restricted” has been carried out in step ST403 (ST404). When the main CPU 11 determines that the setting for “remove a function serving as an object to be restricted” has been carried out (YES in ST404), the main CPU 11 receives the setting of handling of a print job in a case where the restricted function cannot be removed (ST405). As a result, one of the four of “print”, “give a sender of the print job notice and print”, “delete”, and “give a sender of the print job notice and delete” is set. Note that, when the main CPU 11 determines that the setting for “remove a function serving as an object to be restricted” has not been carried out in step ST403 (NO in ST404), the CPU 11 skips the process in step ST405.

Next, the main CPU 11 determines whether or not the setting for “give a sender of the print job notice and print” or “give a sender of the print job notice and delete” has been carried out by settings in steps ST402, ST403, and ST405 (ST406). When the main CPU 11 determines that the aforementioned setting has been carried out in step ST406 (YES in ST406), the main CPU 11 receives the setting of handling of a print job in a case where it is impossible to give a sender of the print job notice (ST407). Accordingly, one of “print” and “delete” is set. Note that, when the main CPU 11 determines that the aforementioned setting has not been carried out in step ST406 (NO in ST406), the main CPU 11 skips the process in step ST407. Then, the main CPU 11 receives the setting for imposing restrictions on a function A in a department X (ST408). The restrictions in which the setting has been received are set in the restriction setting table T1 described in FIG. 3.

On the other hand, when the main CPU 11 determines to set a manner of giving notice with respect to the administrator in step ST401 (YES in ST401), the main CPU 11 receives the setting of a manner of giving notice with respect to the administrator of the printing apparatus 1 (ST409). Consequently, an IP address of the PC 4 of the administrator, an e-mail address of the administrator, or the like is set. Then, the main CPU 11 receives the setting of handling of a print job for which the setting for a department has not been carried out (ST410). In accordance therewith, one of the five of “print”, “give a sender of the print job notice and print”, “delete”, “give a sender of the print job notice and delete”, and “give the administrator of the printing apparatus 1 notice” is set. Subsequently, the main CPU 11 receives the setting of handling of a print job using a restricted function (ST411). Accordingly, one of the six of “print”, “give a sender of the print job notice and print”, “delete”, “give a sender of the print job notice and delete”, “remove a function serving as an object to be restricted”, and “give the administrator of the printing apparatus 1 notice” is set. Then, the main CPU 11 determines whether or not the setting of “remove a function serving as an object to be restricted” has been carried out in step ST411 (ST412). When the main CPU 11 determines that the setting of “remove a function serving as an object to be restricted” has been carried out (YES in ST412), the main CPU 11 receives the setting of handling of a print job in a case where the restricted function cannot be removed (ST413). In accordance therewith, one of the five of “print”, “give a sender of the print job notice and print”, “delete”, and “give a sender of the print job notice and delete”, and “give the administrator of the printing apparatus 1 notice” is set. Note that, when the main CPU 11 determines that setting of “remove a function serving as an object to be restricted” has not been carried out in step ST413 (NO in ST412), the main CPU 11 skips the process in step ST413.

Subsequently, the main CPU 11 determines whether or not the setting of “give a sender of the print job notice and print” or “give a sender of the print job notice and delete” has been carried out by the settings in steps ST410, ST411, and ST413 (ST414). When the main CPU 11 determines that the aforementioned setting has been carried out in step ST414 (YES in ST414), the main CPU 11 receives the setting of handling of a print job in a case where it is impossible to give a sender of the print job notice (ST415). As a result, one of the three of “print”, “delete”, and “give the administrator of the printing apparatus 1 notice” is set. Note that, when the main CPU 11 determines that the aforementioned setting has not been carried out in step ST414 (NO in ST414), the main CPU 11 skips the process in step ST415. Then, the main CPU 11 receives the setting for imposing restrictions on a function A in a department X (ST408). In this way, when the settings at the time of initial-setting is completed, the process is completed.

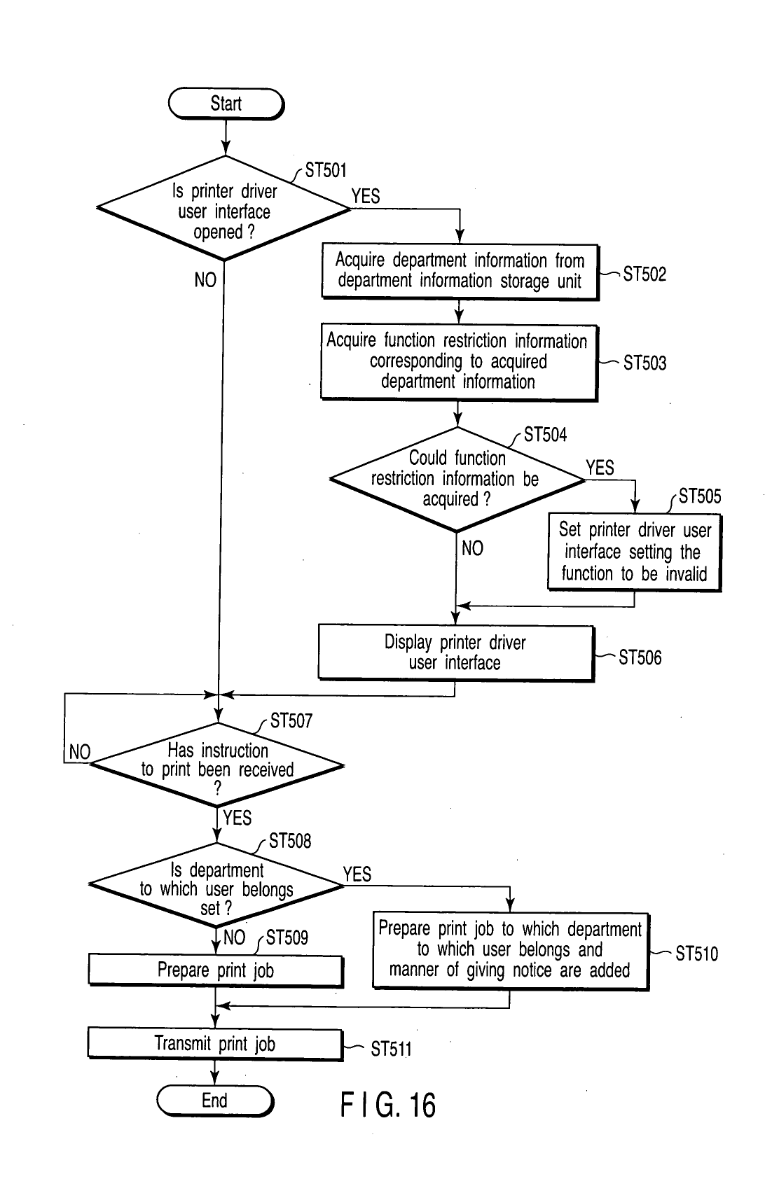

Next, the processes at the time of printing of PC 3 will be described. FIG. 16 is a flowchart showing a process at the time of printing of PC 3.

First, the CPU 31 determines whether or not to open the printer driver user interface (ST501). When the CPU 31 determines to open the printer driver user interface (YES in ST501), the CPU 31 acquires department information indicating a department to which a user belongs (ST502). For example, the department information is acquired from registrations due to an input by the administrator or the user, or the login information of the PC. Then, the CPU 31 communicates with the printing apparatus 1, and acquires from the printing apparatus 1 function restriction information according to the acquired department to which the user belongs, on the basis of the function restriction setting able T1 (ST503). The CPU 31 determines whether or not the aforementioned department is restricted in the function on the basis of the acquired function restriction information (ST504). When the CPU 31 determines that the department is restricted in the function (YES in ST504), the CPU 31 invalidates the user interface for setting the function (ST505). In this way, when the CPU 31 invalidates the user interface (ST505), or determines that the department has not been restricted in the function by the above-described determination (NO in ST504), the CPU 31 displays the printer driver user interface (ST506).

In this way, when the CPU 31 displays the printer driver user interface (ST506), or determines not to open the printer driver user interface (NO in ST501), the CPU 31 determines whether or not an instruction to print is received from the input unit 35 (ST507). When the CPU 31 determines by this determination that the instruction to print is received (YES in ST507), the CPU 31 determines whether or not a department to which a user belongs has been set (ST508). When the CPU 31 determines that a department to which the user belongs has not been set (NO in ST508), the CPU 31 prepares a print job without adding a manner of giving notice which is, for example, an address of a sender of the print job to the header (ST509). Further, when the CPU 31 determines that a department to which the user belongs has been set (YES in ST508), the CPU 31 prepares a print job in which the department to which the user belongs and a manner of giving notice are added to the header thereof (ST510). After preparing the print job in this way, the CPU 31 transmits the print job to the printing apparatus 1 (ST511).

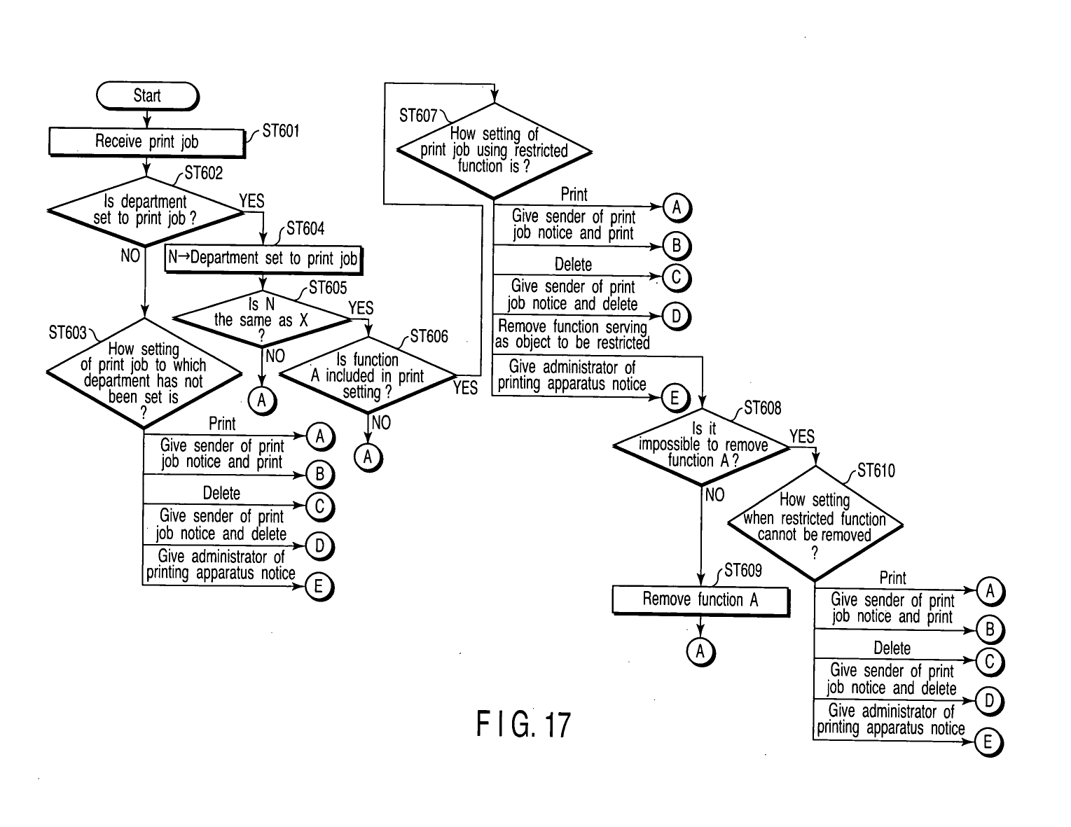

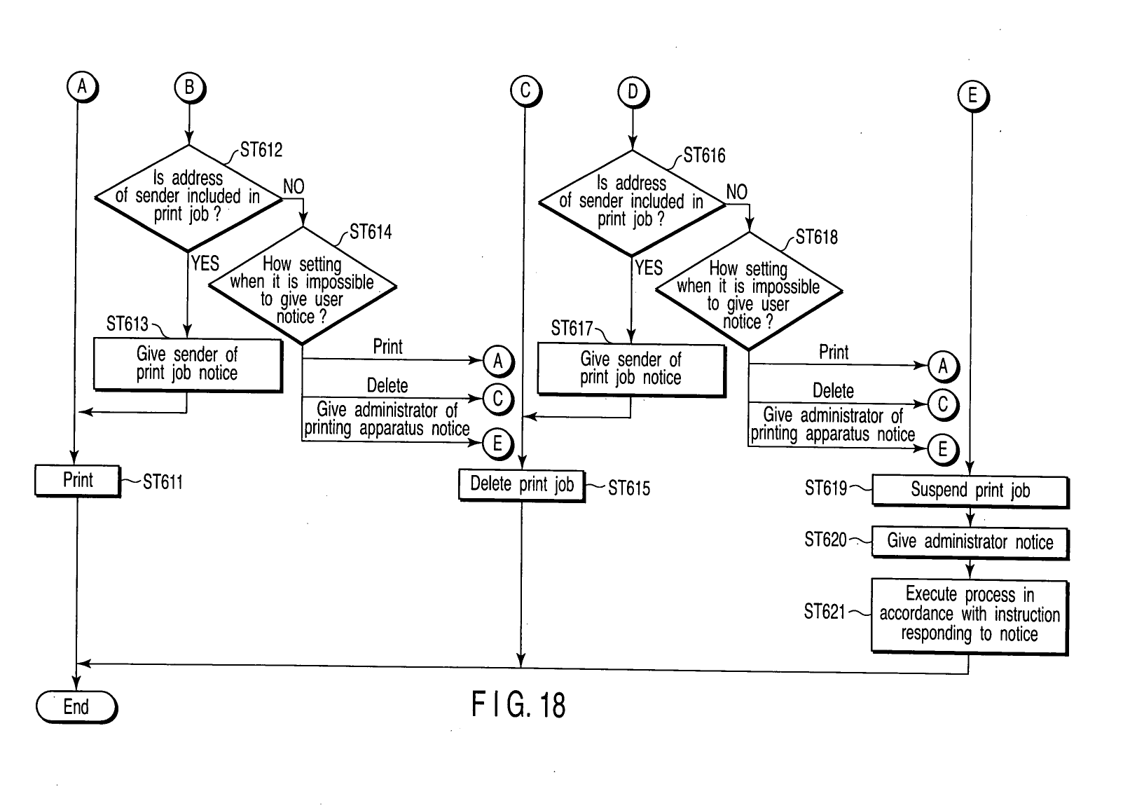

Next, the process of the printing apparatus 1 when a print job has been received will be described. FIGS. 17 and 18 are flowcharts showing a process when the printing apparatus 1 has received a print job from the PC 3.

When the main CPU 11 receives a print job from the PC 3 (ST601), the main CPU 11 determines whether or not department information has been added to the header of the print job, i.e., a department has been set to the print job (ST602). When the main CPU 11 determines that a department has not been set to the print job (NO in ST602), the main CPU 11 determines how the setting of the print job which has been received in step ST402 or ST410 at the time of initial-setting described above, and to which a department has not been set, is set (ST603). Then, the main CPU 11 carries out process corresponding to the setting. To describe concretely, when “print” has been set, the process proceeds to step ST611. When “give a sender of the print job notice and print” has been set, the process proceeds to step ST612. When “delete” has been set, the process proceeds to step ST615. When “give a sender of the print job notice and delete” has been set, the process proceeds to step ST616. When “give the administrator of the printing apparatus 1 notice” has been set, the process proceeds to step ST619.

When the main CPU 11 determines that a department has been set to the print job (YES in ST602), the main CPU 11 regards a variable N as the department set to the print job (ST604). Then, the main CPU 11 determines whether or not the variable N is the same as X (ST605). X denotes a department in which restrictions on the functions registered in the printing apparatus 1 have been set. Namely, the CPU 11 determines whether or not the department set to the received print job is a department in which restrictions on the functions have been set. When the main CPU 11 determines that the variable N is not the same as X (NO in ST605), the process proceeds to step ST610. When the main CPU 11 determines that the variable N is the same as X (YES in ST605), the main CPU 11 determines whether or not a function A is included in the print setting of the print job (ST606). The function A is a function prohibited from being used for the department in the function restriction setting table T1. When the main CPU 11 determines that the function A is not included in the print setting (NO in ST606), the process proceeds to step ST611. When the main CPU 11 determines that the function A is included in the print setting (YES in ST606), the main CPU 11 determines how the setting of the print job which has been received in step ST403 or ST411 at the time of initial-setting, and which uses the restricted functions, is set (ST607). Then, the main CPU 11 carries out process corresponding to the setting. To describe concretely, when “print” has been set, the process proceeds to step ST611. When “give a sender of the print job notice and print” has been set, the process proceeds to step ST612. When “delete” has been set, the process proceeds to step ST615. When “give a sender of the print job notice and delete” has been set, the process proceeds to step ST616. When “remove a function serving as an object to be restricted” has been set, the process proceeds to step ST608. When “give the administrator of the printing apparatus 1 notice” has been set, the process proceeds to step ST619.

In step ST608, the main CPU 11 determines whether or not it is impossible to remove the function A (ST608). When the main CPU 11 determines that it is not impossible to remove the function A (NO in ST608), the main CPU 11 removes the function A from among the settings of the print job (ST609). Then, the process proceeds to step ST611. Further, when the main CPU 11 determines that it is impossible to remove the function A (YES in ST608), the main CPU 11 determines how the setting of the print job, which has been received in step ST405 or ST413 at the time of initial-setting, in a case where it is impossible to remove the restricted functions, is set (ST610). Then, the main CPU 11 carries out process corresponding to the setting. To describe concretely, when “print” has been set, the process proceeds to step ST611. When “give a sender of the print job notice and print” has been set, the process proceeds to step ST612. When “delete” has been set, the process proceeds to step ST615. When “give a sender of the print job notice and delete” has been set, the process proceeds to step ST616. When “give the administrator of the printing apparatus 1 notice” has been set, the process proceeds to step ST619.

In step ST611, the main CPU 11 carries out printing on the basis of the received print job. Further, in step ST 612, the main CPU 11 determines whether or not an address (a manner of giving notice) of the sender is included in the print job. When the main CPU 11 determines that an address of the sender is included in the print job (YES in ST612), the main CPU 11 gives the sender of the print job notice (ST613), and carries out printing on the basis of the received print job (ST611). In addition, when the main CPU 11 determines that an address of the sender is not included in the print job (NO in ST612), the main CPU 11 determines how the setting of handling of the print job, which has been received in step ST407 or ST415 at the time of initial-setting, in a case where it is impossible to give a user notice, is set (ST614). Then, the main CPU 11 carries out process corresponding to the setting. To describe concretely, when “print” has been set, the process proceeds to step ST611. When “delete” has been set, the process proceeds to step ST615. When “give the administrator of the printing apparatus 1 notice” has been set, the process proceeds to step ST619.

In step ST615, the main CPU 11 deletes the received print job. In step ST 616, the main CPU 11 determines whether or not an address of the sender is included in the print job. When the main CPU 11 determines that an address of the sender is included in the print job (YES in ST616), the main CPU 11 gives the sender of the print job notice (ST617), and deletes the received print job (ST615). Further, when the main CPU 11 determines that an address of the sender is not included in the print job (NO in ST616), the main CPU 11 determines how the setting of handling of the print job, which has been received in step ST407 or ST414 at the time of initial-setting, in a case where it is impossible to give a user notice, is set (ST618). Then, the main CPU 11 carries out process corresponding to the setting. Because this process is the same as the determination in step ST614 described above, description thereof will be omitted. In step ST619, the main CPU 11 suspends the print job (ST619), the gives the administrator of the printing apparatus 1 notice (ST620). In this notice, for example, contents such as department information indicating a department which has been added to the header of the print job (the case where a department has not been set is not included), receiving the print job to which the restricted function has been added, the restricted function, an address of a source host of the print job, and the like are included. Then, the main CPU 11 executes process for the suspended print job in accordance with an instruction responding to the aforementioned notice (ST621).

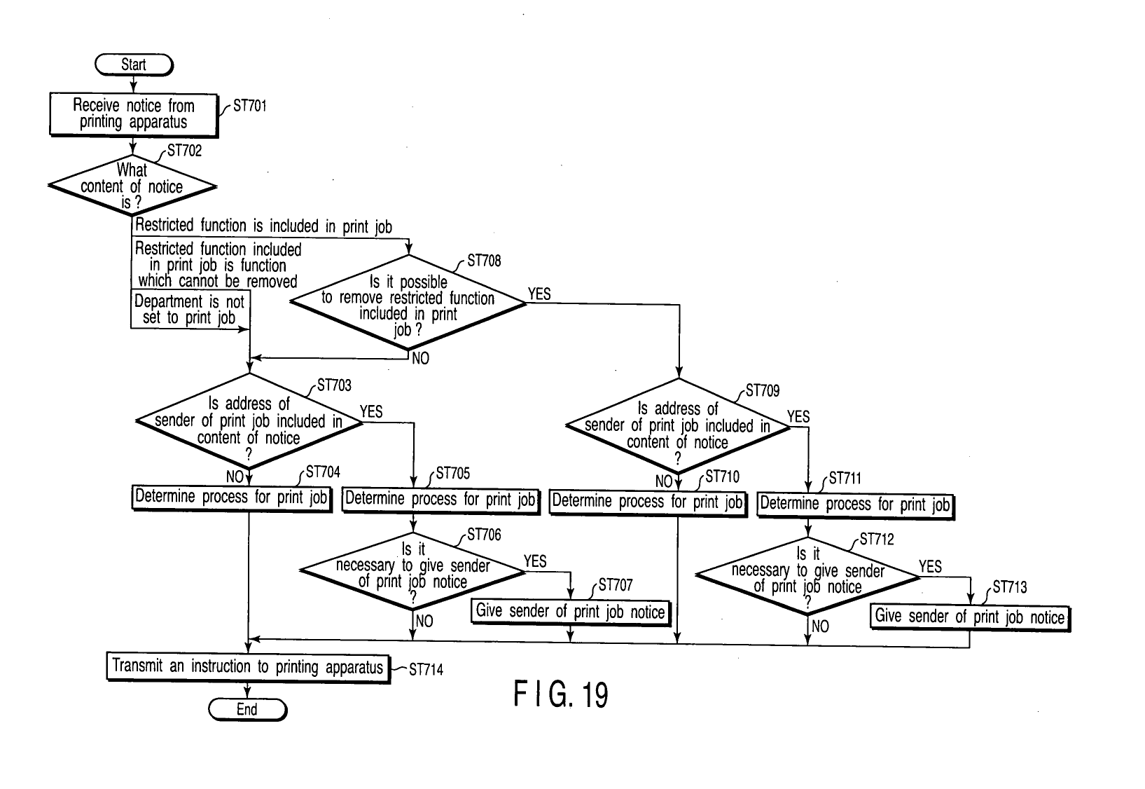

Next, the process of the PC 4 when a notice has reached the PC 4 of the administrator of the printing apparatus 1 from the printing apparatus 1 will be described. FIG. 19 is a flowchart showing the process of the PC 4 of the administrator when a notice has reached from the printing apparatus 1.

When the CPU 31 receives a notice from the printing apparatus 1 (ST701), the CPU 31 determines what the content of the notice is (ST702). When the CPU 31 determines that it is content showing that a restricted function is included in the print job, the process proceeds to step ST708. In addition, when the CPU 31 determines that it is one of content showing that the restricted function included in the print job is a function which cannot be removed, or content showing that a department is not set in the print job, the process proceeds to step ST703.

In step ST703, the CPU 31 determines whether or not an address of the sender of the print job is included in the content of notice. When the CPU 31 determines that an address of the sender of the print job is not included in the content of notice (NO in ST703), the CPU 31 determines the process for the print job to be one of “print” or “delete” (ST704). This determination is made, for example, by carrying out a display for selecting “print” or “delete” on the display unit 34 of the PC 4, and due to the administrator selecting one of those by using the input unit 35. Further, when the CPU 31 determines that an address of the sender of the print job is included in the content of notice (YES in ST703), the CPU 31 determines the process for the print job to be one of “print”, “give a sender of the print job notice and print”, “delete”, and “give a sender of the print job notice and delete” (ST705). This determination is made, for example, by carrying out a display for selecting one of “print”, “give a sender of the print job notice and print”, “delete”, and “give a sender of the print job notice and delete” on the display unit 34 of the PC 4, and due to the administrator selecting one of those by using the input unit 35. In this way, when one of “print”, “give a sender of the print job notice and print”, “delete”, and “give a sender of the print job notice and delete” is set, the CPU 31 determines whether or not it is necessary to notify the sender of the print job of the setting (ST706). To describe concretely, it is determined in accordance with whether or not it has been determined to be one of “give a sender of the print job notice and print” and “give a sender of the print job notice and delete” is determined in step ST705. When it has been determined to be one of “give a sender of the print job notice and print” and “give a sender of the print job notice and delete” (YES in ST706), the CPU 31 gives the sender of the print job notice (ST707). Note that, when it is determined that there is no need to give the sender of the print job notice, concretely, when it is determined to be “print” or “delete” (NO in ST706), the CPU 31 skips the process in step ST707. In this way, when the process for the print job is determined (ST704, ST705), the CPU 31 transmits an instruction to the printing apparatus 1 on the basis of the determination (ST714).

In step ST708, the CPU 31 determines whether or not it is possible to remove the restricted function included in the print job. When the CPU 31 determines that it is not possible to remove the aforementioned function (NO in ST708), the process returns to step ST703 described above. In addition, when the CPU 31 determines that it is possible to remove the aforementioned function (YES in ST708), the CPU 31 determines whether or not an address of the sender of the print job is included in the content of notice (ST709). When the CPU 31 determines that an address of the sender is not included in the content of notice (NO in ST709), the CPU 31 determines the process for the print job to be one of “print”, “remove the aforementioned function and print”, and “delete” (ST710). This determination is made, for example, by carrying out a display for selecting “print”, “remove the aforementioned function and delete”, or “delete” on the display unit 34 of the PC 4, and due to the administrator selecting one of those by using the input unit 35 of the PC 4. Further, when the CPU 31 determines that an address of the sender of the print job is included in the content of notice (YES in ST709), the CPU 31 determines the process for the print job to be one of “print”, “give a sender of the print job notice and print”, “delete”, and “give a sender of the print job notice and delete” (ST711). This determination is made, for example, by carrying out a display for selecting one of “print”, “give a sender of the print job notice and print”, “remove the function, and print”, “give a sender of the print job notice, remove the function, and print”, “delete”, and “give a sender of the print job notice and delete” on the display unit 34.of the PC 4, and due to the administrator selecting one of those by using the input unit 35 of the PC 4. In this way, when one of “print”, “give a sender of the print job notice and print”, “print” directly after removing the function, “give a sender of the print job notice, remove the function, and print”, “delete”, and “give a sender of the print job notice and delete” is set, the CPU 31 determines whether or not it is necessary to notify the sender of the setting (ST712). To describe concretely, it is determined in accordance with whether or not it has been determined to be one of “give a sender of the print job notice and print”, “give a sender of the print job notice, remove the function, and print”, and “give a sender of the print job notice and delete”. When it is determined that it is necessary to give the sender of the print job notice (YES in ST712), the CPU 31 gives the sender of the print job notice (ST713). Note that, when it is determined that there is no need to give the sender of the print job notice, concretely, when it is determined to be “print”, “remove the function and print”, or “delete” (NO in ST712), the CPU 31 skips the process in step ST713. In this way, when the process for the print job is determined (ST710, ST711), the CPU 31 transmits an instruction to the printing apparatus 1 on the basis of the determination (ST714).

Next, the effect of the printing system structured in this way will be described by using a case where a user of a PC 3 in the first department transmits a print job to which a staple function (a staple function is a function which can be removed.) has been added, to the printing apparatus 1. Note that the print job includes department information indicating the first department, information instructing to execute stapling, and an address in the LAN 2 of the sender of the PC 3. These items of information are included in the print job on the basis of the setting received at the time of initial-setting. Further, as the initial setting of the printing apparatus 1, with respect to the setting of the print job using the restricted function, a notice to the administrator of the printing apparatus 1, i.e., a notice (e-mail) to the PC 4 is set.

When such a print job is transmitted from the PC 3 to the printing apparatus 1, it is determined that, in the printing apparatus 1, a department has been set to the print job, and the department is a department set in the restriction setting table T1, and a function restricted to the set department is included in the print setting of the print job. Suppose that the printing apparatus 1 notifies the PC 4 of the print job using the restricted function. Therefore, the printing apparatus 1 suspends the print job, and transmits an e-mail including an address of the PC 3 or the like to the effect that the print job using the restricted function has been received.

The PC 4 determines whether or not the staple function included in the print job can be removed on the basis of the content of the e-mail after receiving the aforementioned e-mail. Because the staple function can be removed, it is determined whether or not an address of the sender of the print job is included on the basis of the content notified by the e-mail. Further, the PC 4 carries out an display for receiving one selection of the four of “print”, “give a sender of the print job notice and print”, “delete”, and “give a sender of the print job notice and delete”, on the display unit 34 in order to determine the process for the print job, and receives the selection from the input unit 35. When, for example, “give a sender of the print job notice and print” is selected by the administrator, a notice of the content as follows is carried out with respect to the PC 3. The content of this notice is, for example, “although the staple function is restricted in the first department, because the staple function is allowed by the administrator, printing will be carried out”. Then, the PC 4 transmits an instruction indicating printing to the printing apparatus 1. The printing apparatus 1 carries out printing on the basis of the print job which has been suspended after receiving the instruction.

In accordance with the second embodiment, when the printing apparatus 1 which can impose restrictions on utilizing the functions which the printing apparatus 1 has for the respected registered departments receives a print job set so as to be notified to the PC 4 of the administrator of the printing apparatus 1, the printing apparatus 1 once suspends the print job, and gives the PC 4 notice of the received print job. The administrator can determine the process for the print job on the basis of the notice. Consequently, in a case where a user in a department in which restrictions on utilizing the functions of the printing apparatus 1 are imposed wishes to exceptionally utilize the function prohibited from being used, or the like, the administrator of the printing apparatus 1 can determine the process for the print job for each print job without canceling the entire restrictions on the department.

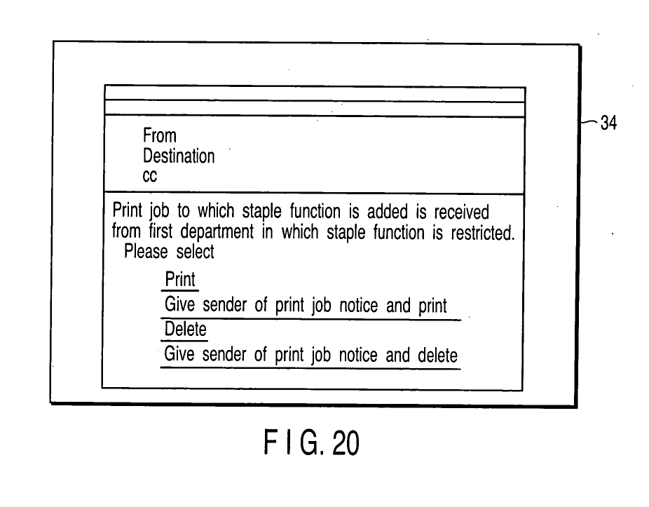

Note that, the above-described second embodiment describes the case where the information for carrying out the determinations in steps ST702, ST703, ST708, and ST709 described above are included in the content of notice when the printing apparatus 1 gives the PC 4 of the administrator notice by e-mail. However, not that the determinations in steps ST702, ST703, ST708, and ST709 are carried out by the PC 4, but these determinations may be carried out by the printing apparatus 1. To described concretely, after the determinations in steps ST702, ST703, ST708, and ST709 are carried out between the steps ST619 and ST620 described above, the printing apparatus 1 gives the PC 4 of the administrator notice in ST620. At that time, a type of an instruction to receive a determination of the process for the print job from the administrator is included in the content of notice notified to the PC 4. For example, when it is determined that an address of the sender of the print job is included in step ST703 (YES in ST703), it is necessary to receive an instruction for carrying out process of “print”, “give a sender of the print job notice and print”, “delete”, and “give a sender of the print job notice and delete” as the process for the print job, from the administrator. Therefore, a notice for receiving an instruction for carrying out process of the above-described four types of processes is made to the PC 4. FIG. 20 is a diagram showing an example when the content of notice at that time is displayed on the display unit 34 of the PC 4. As shown in FIG. 20, a display on which the administrator selects process of “print”, “give a sender of the print job notice and print”, “delete”, and “give a sender of the print job notice and delete” is made on the display unit 34 of the PC 4. When the administrator selects process from among the displayed processes in this way by using the input unit 35 of the PC 4, the selected content is transmitted as an instruction to the printing apparatus 1. Then, the printing apparatus 1 executes the process for the print job on the basis of the received instruction. In this way, the present invention may be configured such that, after a type of the process for the received print job is determined by the printing apparatus 1, the printing apparatus 1 gives the PC 4 of the administrator notice.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the inventive as defined by the appended claims and equivalents thereof.

What is claimed is:

1. A printing system in a network that connects a plurality of computers and a printing apparatus, the printing apparatus receiving a print job from the computers and performing printing based on the received print job, the printing system comprising:
a function restriction information storage unit which stores function restriction information that restricts a printing function for each of groups divided according to users of the computers; and
a control unit which inhibits a restricted printing function from being fulfilled based on the function restriction information stored in the function restriction information storage unit in accordance with a group of one of the computers when the one of the computers uses the printing apparatus to perform printing.

2. The printing system according to claim 1, wherein the control unit is provided in each of the computers, and the function restriction information storage unit is provided in the printing apparatus.

3. The printing system according to claim 2, wherein the computers each includes an input unit, a display unit which displays a user interface to receive a setting of the printing function, and a group information storage unit which stores group information indicating which of the groups each of the computers belongs to, and
the control unit performs a process of acquiring function restriction information corresponding to the group stored in the group information storage unit from the printing apparatus when the user interface is displayed and a process of displaying the user interface on the display unit while refusing to receive an instruction of the restricted function based on the acquired function restriction information.

4. The printing system according to claim 3, wherein the restricted function is displayed on the user interface in color different from that of a not restricted function.

5. The printing system according to claim 3, wherein the restricted function is at least one of a punch function, a staple function, a reverse function, an Nin1 function and a toner save function.

6. The printing system according to claim 1, wherein the control unit and the function restriction information storage unit are provided in the printing apparatus.

7. The printing system according to claim 6, wherein the computers each include a group information storage unit which stores group information indicating which of the groups each of the computers belongs to, and
the control unit performs a process of determining whether function restriction information corresponding to a group indicated by the group information is stored in the function restriction information storage unit when the control unit receives a print job including the group information, a process of determining whether a function restricted by the function restriction information is included in a printing setting of the print job when the control unit determines that the function restriction information is stored in the function restriction information storage unit, and a process of inhibiting the restricted printing function from being fulfilled when the control unit determines that the restricted function is included in the printing setting.

8. The printing system according to claim 7, wherein the process of inhibiting the restricted function from being fulfilled is a process of deleting the print job.

9. The printing system according to claim 7, wherein the process of inhibiting the restricted function from being fulfilled is a process of deleting the restricted function from the print job.

10. The printing system according to claim 7, wherein the restricted function is at least one of a punch function, a staple function, a reverse function, an Nin1 function and a toner save function.

11. A printing method of a printing system in a network that connects a plurality of computers and a printing apparatus, the printing apparatus receiving a print job from the computers and performing printing based on the received print job, the printing method comprising:
acquiring function restriction information that restricts a printing function for each of groups divided according to users of the computers; and
inhibiting a restricted printing function from being fulfilled based on the function restriction information corresponding to a group of one of the computers when the one of the computers uses the printing apparatus to perform printing.

12. A printing apparatus that is connected to a plurality of computers via a network to receive a print job from the computers and perform printing based on the received print job, the printing apparatus comprising:
a function restriction information storage unit which stores function restriction information that restricts a printing function for each of groups divided according to users of the computers; and
a control unit which inhibits a restricted printing function from being fulfilled based on the function restriction information stored in the function restriction information storage unit in accordance with a group indicated by group information when the control unit receives a print job including the group information.

13. The printing system according to claim 12, wherein the control unit performs a process of determining whether function restriction information corresponding to a group indicated by the group information is stored in the function restriction information storage unit when the control unit receives a print job including the group information, a process of determining whether a function restricted by the function restriction information is included in a printing setting of the print job when the control unit determines that the function restriction information is stored in the function restriction information storage unit, and a process of inhibiting the restricted printing function from being fulfilled when the control unit determines that the restricted function is included in the printing setting.

14. The printing system according to claim 13, wherein the process of inhibiting the restricted function from being fulfilled is a process of deleting the print job.

15. The printing system according to claim 13, wherein the process of inhibiting the restricted function from being fulfilled is a process of deleting the restricted function from the print job.

16. The printing system according to claim 13, wherein the restricted function is at least one of a punch function, a staple function, a reverse function, an Nin1 function and a toner save function.

17. A printing apparatus connected to a plurality of computers and a computer of an administrator who administrates the printing apparatus via a network, the printing apparatus receiving a print job from the computers, and executing printings on the basis of the received print job, the printing apparatus comprising:
a determining unit which determines that it is necessary to give the computer of the administrator notice of the received print job on the basis of information indicating groups divided in accordance with users of said plurality of computers included in the print job when a print job is received from one of said plurality of computers, restriction on a function of printing corresponding to the groups, and a condition under which a notice of the print job which has been set in advance is carried out with respect to the computer of the administrator;
a notifying unit which, when it is determined at the determining unit that it is necessary to give notice of the print job, once suspends the received print job, and gives the computer of the administrator notice of the print job; and
a processing unit which, when information indicating an instruction relating to process for the print job responding to the notice from the notifying unit is received, carries out process based on the instruction even if the function of printing included in the print job has been restricted.

18. The printing apparatus according to claim 17, wherein content of the notice of the print job includes the groups, receiving of the print job having a restricted function, and the content of the restricted function.

19. The printing apparatus according to claim 18, wherein the content of the notice of the print job further includes information for giving a computer of a source host notice.
